(19) United States
(12) Patent Application Publication
(10) Pub. No.: US 2026/0247411 A1
(43) Pub. Date: Aug. 20, 2026

(54) (RE)SELECTION OF LOGICAL CHANNEL PRIORITIZATION (LCP) PROCEDURE AND RADIO RESOURCE MANAGEMENT

(71) Applicant: Telefonaktiebolaget LM Ericsson (publ), Stockholm (SE)

(72) Inventors: Zhang Zhang, Beijing (CN); Min Wang, Lulea (SE)

(21) Appl. No.: 19/471,950

(22) PCT Filed: Apr. 2, 2024
(86) PCT No.: PCT/CN2024/085510

§ 371 Date: Oct. 2, 2025

(30) Foreign Application Priority Data
Apr. 6, 2023 (WO) PCT/CN2023/086509

(51) Int. Cl. H04W 72/25; H04W 72/566; H04W 74/0808

(52) U.S. Cl. CPC H04W 72/25; H04W 72/569; H04W 74/0808

(57) ABSTRACT

A User Equipment (UE), a network node, and methods for (re)selection of logical channel prioritization (LCP) procedure and/or radio resource management. A method at a UE for LCP procedure selection comprises: receiving, from a second UE, a first message indicating first Channel Occupancy Time (COT) information for sharing a first COT with the UE; and selecting a first LCP procedure or a second LCP procedure based on one or more selection conditions in response to receiving the first message.

### CROSS-REFERENCE TO RELATED APPLICATION(S)

This application claims priority to the PCT International Application No. PCT/CN2023/086509, entitled “ (RE)SELECTION OF LOGICAL CHANNEL PRIORITIZATION (LCP) PROCEDURE AND RADIO RESOURCE MANAGEMENT”, filed on Apr. 6, 2023, which is incorporated herein by reference in its entirety.

### TECHNICAL FIELD

The present disclosure is related to the field of telecommunication, and in particular, to a User Equipment (UE), a network node, and methods for (re)selection of logical channel prioritization (LCP) procedure and/or radio resource management.

### BACKGROUND

Networks have always been hierarchical in nature. Devices have connected to and communicated with one or more base stations ever since the birth of cellular communications. However, new technology enablers in 5G New Radio (NR) will allow devices to connect directly to one another using a technique called sidelink communications. Sidelink (SL) is the new communication paradigm in which cellular devices are able to communicate without relaying their data via the network. That means vehicles, robots, and even consumer gadgets could create their own ad hoc networks without using the radio access network as an intermediary.

In the past decade new types of cellular services that go beyond traditional mobile broadband have had a strong impact on the scoping and development of the 5G NR standard. These new cellular services were motivated by the business and economic needs of making the 3rd Generation Partnership Project (3GPP) ecosystem capable of supporting industrial requirements ranging from direct automotive communication between vehicles to industrial automation with Ultra-Reliable Low-Latency Communication (URLLC) for mission-and business-critical applications. But these same technologies can also be used for consumers to enhance their communication experience. For instance, sidelink proximity services would allow devices to discover and communicate with one another at extremely high data rates and low latency, making them ideal for peer-to-peer gaming and streaming services as well as enhanced Augmented Reality (AR), Virtual Reality (VR) and other wearable device communications. In contrast with uplink and downlink between a UE and a base station, where resource allocation and link adaptation are controlled by the network, in sidelink the device may perform both functions autonomously. In other words, the device gains more control of how to use network resources. At the same time, it is expected that 3GPP upcoming Release will introduce support for sidelink-based relaying and that in future releases multi-link relay will also be considered. Sidelink is also a candidate for future releases as an Industrial Internet of Things (IoT) enabler. By restricting the communication link to one hop, latency is greatly reduced, which is key to mission-critical industrial applications. Furthermore, sidelink is a potential solution for public safety ensuring direct communication or relayed communication between devices.

Another potential use case is multi-hop relaying where multiple sidelink connections are used to leap from/to device to achieve less power consumption, overcome link budget constraints, and enhance latency and reliability. Gaming and entertainment services with AR/VR can also take advantage of sidelink, as will body networks, using direct 5G connections to replace the Bluetooth and eventually Wi-Fi links that currently connect these devices. The result could be a revolutionary change in the communication architecture for many consumer devices. Instead of providing a different radio interface for every use case, device vendors could rely solely on 5G as the link for wide area, local area and personal area communications.

### SUMMARY

In the 3GPP Release 18, a Work Item (WI) on sidelink enhancement has been approved (RP-213678), and one of the objectives is to study and specify support of sidelink on unlicensed spectrum (SL-U).

In Technical Specification Group (TSG) Radio Access Network 1 (RAN1), it was agreed that UE to UE Channel Occupancy Time (COT) sharing is supported for SL-U where Type 2 channel access procedure as defined for NR-U can be applied.

Furthermore, when a responding UE uses a COT shared by a COT initiating UE for its transmission(s), the COT initiating UE is required to be a target receiver of the responding UE's transmission(s).

One way to meet this requirement is to modify the LCP procedure so that only destinations associated to the COT initiating UEs are considered in LCP. Meanwhile, a UE should not be forced to use a shared COT. In RAN2, the following was agreed in RAN2 #112:

UE can select either to do a changed LCP in order to satisfy the COT requirement, and to do the type-2 LBT, or to do a legacy LCP, and using type-1 or type-2 LBT (i.e., use the COT if that is feasible with the legacy LCP). For further study (FFS) on spec impact, e.g., conditions for UE to choose either solution.

From the above agreement, the detailed conditions based on which the UE can determine to apply either of the two options below are unknown.
Option 1: UE can select to do a changed LCP in order to satisfy the COT requirement, and to do the type-2 Listen-Before-Talk (LBT);
Option 2: UE does a legacy LCP, and uses type-1 or type-2 LBT (i.e., use the COT if that is feasible with the legacy LCP).

Therefore, the detailed conditions based on which the UE can determine to apply either of the two options are needed.

To address or at least partially alleviate one or more of the above issues, some embodiments of the present disclosure are provided.

According to a first aspect of the present disclosure, a method at a UE for LCP procedure selection is provided. The method comprises: receiving, from a second UE, a first message indicating first Channel Occupancy Time (COT) information for sharing a first COT with the UE; and selecting a first LCP procedure or a second LCP procedure based on one or more selection conditions in response to receiving the first message.

Further, some other embodiments of the first aspect are described below in the Detailed Description.

According to a second aspect of the present disclosure, a method at a UE for LCP procedure reselection is provided. The method comprises: selecting one of a first LCP procedure and a second LCP procedure to build a first Medium Access Control (MAC) Protocol Data Unit (PDU); receiving, from a second UE, a first message indicating first COT information for sharing a first COT with the UE; and determining whether the other of the first LCP procedure and the second LCP procedure is to be reselected in response to receiving the first message. Further, some other embodiments of the second aspect are described below in the Detailed Description.

According to a third aspect of the present disclosure, a method at a UE for radio resource management is provided. The method comprises: obtaining one or more first radio resources; receiving, from a second UE, a first message indicating first COT information for sharing a first COT with the UE, determining whether the one or more first radio resources are within or overlapped with one or more bandwidth ranges where the first COT is shared; and attempting to obtain one or more second radio resources within or overlapped with the one or more bandwidth ranges in response to determining that the one or more first radio resources are not within or overlapped with the one or more bandwidth ranges. Further, some other embodiments of the third aspect are described below in the Detailed Description.

According to a fourth aspect of the present disclosure, a UE is provided. The UE comprises: a processor; a memory storing instructions which, when executed by the processor, cause the processor to perform any of the methods of the first aspect.

According to a fifth aspect of the present disclosure, a UE is provided. The UE comprises: a processor; a memory storing instructions which, when executed by the processor, cause the processor to perform any of the methods of the second aspect.

According to a sixth aspect of the present disclosure, a UE is provided. The UE comprises: a processor; a memory storing instructions which, when executed by the processor, cause the processor to perform any of the methods of the third aspect.

According to a seventh aspect of the present disclosure, a UE for LCP procedure selection is provided. The UE comprises: a receiving module configured to receive, from a second UE, a first message indicating first COT information for sharing a first COT with the UE; and a selecting module configured to select a first LCP procedure or a second LCP procedure based on one or more selection conditions in response to receiving the first message. In some embodiments, the UE may comprise one or more further modules, each of which may perform any of the methods of the first aspect.

According to an eighth aspect of the present disclosure, a UE for LCP procedure reselection is provided. The UE comprises: a selecting module configured to select one of a first LCP procedure and a second LCP procedure to build a first MAC PDU; a receiving module configured to receive, from a second UE, a first message indicating first COT information for sharing a first COT with the UE; and a determining module configured to determine whether the other of the first LCP procedure and the second LCP procedure is to be reselected in response to receiving the first message. In some embodiments, the UE may comprise one or more further modules, each of which may perform any of the methods of the second aspect.

According to a ninth aspect of the present disclosure, a UE for radio resource management is provided. The UE comprises: an obtaining module configured to obtain one or more first radio resources; a receiving module configured to receive, from a second UE, a first message indicating first COT information for sharing a first COT with the UE; a determining module configured to determine whether the one or more first radio resources are within or overlapped with one or more bandwidth ranges where the first COT is shared; and an attempting module configured to attempt to obtain one or more second radio resources within or overlapped with the one or more bandwidth ranges in response to determining that the one or more first radio resources are not within or overlapped with the one or more bandwidth ranges. In some embodiments, the UE may comprise one or more further modules, each of which may perform any of the methods of the third aspect.

According to a tenth aspect of the present disclosure, a method at a network node for facilitating a UE in radio resource management is provided. The method comprises: transmitting, to the UE, a fourth message indicating one or more first radio resources for transmission associated with the UE; receiving, from the UE, a second message for obtaining one or more radio resources within one or more bandwidth ranges; and transmitting, to the UE, a third message indicating one or more second radio resources within at least one of the one or more bandwidth ranges. Further, some other embodiments of the tenth aspect are described below in the Detailed Description. According to an eleventh aspect of the present disclosure, a network node is provided. The network node comprises: a processor; a memory storing instructions which, when executed by the processor, cause the processor to perform any of the methods of the tenth aspect.

According to a twelfth aspect of the present disclosure, a network node for facilitating a UE in radio resource management is provided. The network node comprises: a first transmitting module configured to transmit, to the UE, a fourth message indicating one or more first radio resources for transmission associated with the UE; a receiving module configured to receive, from the UE, a second message for obtaining one or more radio resources within one or more bandwidth ranges; and a second transmitting module configured to transmit, to the UE, a third message indicating one or more second radio resources within at least one of the one or more bandwidth ranges. In some embodiments, the network node may comprise one or more further modules, each of which may perform any of the methods of the tenth aspect.

According to a thirteenth aspect of the present disclosure, a computer program comprising instructions is provided. The instructions, when executed by at least one processor, cause the at least one processor to carry out any of the methods of any of the first, second, third, and tenth aspects.

According to a fourteenth aspect of the present disclosure, a carrier containing the computer program of the thirteenth aspect is provided. In some embodiments, the carrier is one of an electronic signal, optical signal, radio signal, or computer readable storage medium.

According to a fifteenth aspect of the present disclosure, a telecommunication system is provided. The telecommunication system comprises: one or more UEs of any of the fourth, fifth, sixth, seventh, eighth and/or ninth aspects; and at least one network node of the eleventh and/or the twelfth aspects.

With some embodiments of the present disclosure, the type of LCP to be performed can be selected/reselected properly and the resources can be obtained properly when a changed LCP is performed in a shared COT, which is crucial for SL operation in unlicensed band.

### BRIEF DESCRIPTION OF THE DRAWINGS

FIG. 1 is a diagram illustrating an exemplary network in which (re)selection of LCP procedure and/or radio resource management may be applicable according to an embodiment of the present disclosure.

FIG. 2 is a flow chart illustrating an exemplary method at a UE for LCP procedure selection according to an embodiment of the present disclosure.

FIG. 3 is a flow chart illustrating an exemplary method at a UE for LCP procedure reselection according to an embodiment of the present disclosure.

FIG. 4 is a flow chart illustrating an exemplary method at a UE for radio resource management according to an embodiment of the present disclosure.

FIG. 5 is a flow chart illustrating an exemplary method at a network node for facilitating a UE in radio resource management according to an embodiment of the present disclosure.

FIG. 6 schematically shows an embodiment of an arrangement which may be used in UEs or a network node according to an embodiment of the present disclosure.

FIG. 7 is a block diagram of an exemplary UE according to an embodiment of the present disclosure.

FIG. 8 is a block diagram of another exemplary UE according to another embodiment of the present disclosure.

FIG. 9 is a block diagram of yet another exemplary UE according to yet another embodiment of the present disclosure.

FIG. 10 is a block diagram of an exemplary network node according to an embodiment of the present disclosure.

FIG. 11 shows an example of a communication system in accordance with some embodiments of the present disclosure.

FIG. 12 shows an exemplary UE in accordance with some embodiments of the present disclosure.

FIG. 13 shows an exemplary network node in accordance with some embodiments of the present disclosure.

FIG. 14 is a block diagram of an exemplary host, which may be an embodiment of the host of FIG. 11, in accordance with various aspects described herein.

FIG. 15 is a block diagram illustrating an exemplary virtualization environment in which functions implemented by some embodiments may be virtualized.

FIG. 16 shows a communication diagram of an exemplary host communicating via an exemplary network node with an exemplary UE over a partially wireless connection in accordance with some embodiments of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure.

Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first”, “second”, “third”, “fourth,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of 5G NR, the present disclosure is not limited thereto. In fact, as long as (re)selection of LCP procedure and/or radio resource management are involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division-Synchronous CDMA (TD-SCDMA), CDMA2000, Worldwide Interoperability for Microwave Access (WiMAX), Wireless Fidelity (Wi-Fi), 4^{th} Generation Long Term Evolution (LTE), LTE-Advance (LTE-A), or 5G NR, etc. Therefore, one skilled in the arts could readily understand that the terms used herein may also refer to their equivalents in any other infrastructure. For example, the term “UE” used herein may refer to a terminal device, a mobile device, a mobile terminal, a mobile station, a user device, a user terminal, a wireless device, a wireless terminal, or any other equivalents. For another example, the term “network node” used herein may refer to a transmission reception point (TRP), a base station, a base transceiver station, an access point, a hot spot, a NodeB, an Evolved NodeB (eNB), a gNB, a network element, or any other equivalents.

Further, following 3GPP documents are incorporated herein by reference in their entireties:
3GPP TSG RAN Meeting #94e, RP-213678, “New WID on NR sidelink evolution” , Electronic Meeting, Dec. 6-17, 2021 (revision of RP-213672);
3GPP TS 37.213 V17.4.0 (2022-12), Technical Specification, 3rd Generation Partnership Project; Technical Specification Group Radio Access Network; Physical layer procedures for shared spectrum channel access (Release 17);
3GPP TS 38.321 V17.2.0 (2022-09), Technical Specification, 3rd Generation Partnership Project; Technical Specification Group Radio Access Network; NR; Medium Access Control (MAC) protocol specification (Release 17); and
3GPP TS 38.331 V 17.2.0 (2022-09), Technical Specification, 3rd Generation Partnership Project; Technical Specification Group Radio Access Network; NR; Radio Resource Control (RRC) protocol specification (Release 17).

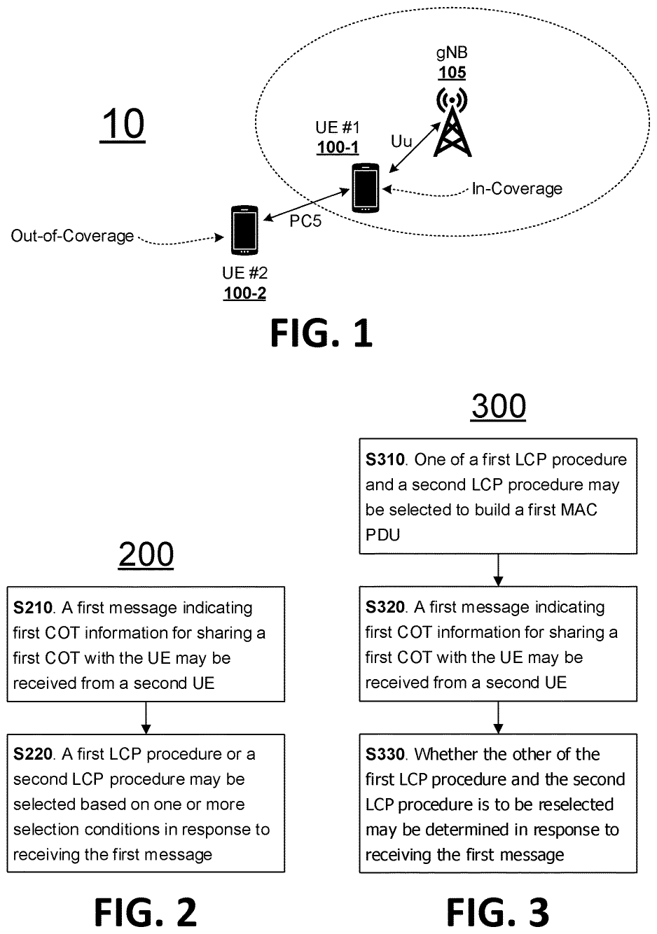

FIG. 1 is a diagram illustrating an exemplary network 10 in which (re)selection of LCP procedure and/or radio resource management may be applicable according to an embodiment of the present disclosure. Although the network 10 is a network defined in the context of 5G NR, the present disclosure is not limited thereto.

As shown in FIG. 1, the network 10 may comprise one or more UEs 100-1 and 100-2 (collectively, UE(s) 100) and a RAN node 105, which could be a base station, a Node B, an evolved NodeB (eNB), a gNB, or an Access Network (AN) node which provides the UE #1 100-1 with access to the network 10. Further, the network 10 may comprise other nodes and/or entities that are not shown in FIG. 1, for example (but not limited to), an Access & Mobility Management Function (AMF), a Session Management Function (SMF), a Policy Control Function (PCF), and/or a User Plane Function (UPF). Further, as shown in FIG. 1, the UEs 100 may communicate with each other via sidelink over the reference point PC5, and the UE 100-1 may communicate with the gNB 105 over the reference point Uu. As also shown in FIG. 1, the UE 100-1 may be located in the coverage of the gNB 105 and served by the gNB 105 while the UE 100-2 may be out of coverage of the gNB 105 and not served by the gNB 105.

However, the present disclosure is not limited thereto. In some other embodiments, the network 10 may comprise additional network functions, less network functions, or some variants of the existing network functions shown in FIG. 1. For example, in a network with the 4G architecture, the entities which perform these functions may be different from those shown in FIG. 1. For another example, in a network with a mixed 4G/5G architecture, some of the entities may be same as those shown in FIG. 1, and others may be different. Further, the functions shown in FIG. 1 are not essential to the embodiments of the present disclosure. In other words, some of them may be missing from some embodiments of the present disclosure. For example, in some embodiments, there is no gNB or there are one or more gNBs that serve some or all of the UEs 100, respectively.

In order to tackle with the ever increasing data demanding, NR is supported on both licensed and unlicensed spectrum (i.e., referred to as NR-U). Compared to the LTE Licensed-Assisted Access (LAA), NR-U supports Dual Connectivity (DC) and standalone scenarios, where the MAC procedures including Random Access Channel (RACH) and scheduling procedure on unlicensed spectrum are subject to the LBT failures, while there was no such restriction in LTE LAA, since there was licensed spectrum in LAA scenario so the RACH and scheduling related signaling can be transmitted on the licensed spectrum instead of unlicensed spectrum.

Access to a channel in the unlicensed spectrum, especially in the 5 GHz and 6 GHz band, is guaranteed by LBT requirements defined by regulations, unlike licensed spectrum which is assigned to a specific operator.

The LBT mechanism mandates a device to sense for the presence of other users' transmissions in the channel before attempting to transmit. The device performs clear channel assessment (CCA) checks on the channel using energy detection (ED) before transmitting. If the channel is found to be idle, i.e. energy detected is below a certain threshold, the device is allowed to transmit. Otherwise, if the channel is found to be occupied (i.e., LBT is failed), the device must defer from transmitting. This mechanism reduces interferences and collisions to other systems and increases probabilities of successful transmissions. After sensing the medium to be idle, the node is typically allowed to transmit for a certain amount of time, sometimes referred to as transmission opportunity (TXOP). The length of the TXOP depends on regulation and type of CCA that has been performed, but typically ranges from 1 ms to 10 ms. This duration is often referred to as a COT (Channel Occupancy Time).

NR-U supports two different LBT modes, dynamic and semi-static channel occupancy for two types of equipment; Load based Equipment (LBE) and Frame based equipment (FBE), respectively.

When a node, referred to as an initiating node (e.g. gNB/UE in case of NR-U), initiates a channel occupancy by performing a type 1 LBT with an exponential random back-off, it is allowed to share its channel occupancy with other nodes, referred to as responding nodes (UEs/gNB). Depending on the gap between the transmission of the initiating and the responding node, the responding node might or might not be required to perform an LBT for a single observation duration, referred to as type 2 LBT. NR-U supports three flavors of type 2 LBT:
Type 2A: Sensing for 25 us immediately before the start of the transmission;
Type 2B: Sensing for 16 us immediately before the start of the transmission;
Type 2C: Immediate transmission without sensing. The duration of the corresponding transmission is at most 584 μs.

As in NR licensed, it is expected that NR-U will support transmission over a wide bandwidth (>>20 MHz). It is expected that this can be achieved in two different ways: (1) carrier aggregation with configuration of multiple serving cells, e.g., each with 20 MHz bandwidth, and (2) configuration of a single wideband serving cell with bandwidth as an integer multiple of 20 MHz, e.g., 80 MHz.

The following objective has been studied for NR-U in 3GPP Rel-16 :

Wide band operation (in integer multiples of 20 MHz) for DL and UL for NR-U supported with multiple serving cells, and wideband operation (in integer multiples of 20 MHz) for DL and UL for NR-U supported with one serving cell with bandwidth>20 MHz with potential scheduling constraint subject to input from RAN2 and RAN4 on feasibility of operating the wideband carrier when LBT is unsuccessful in one or more LBT subbands within the wideband carrier. For all wide-band operation cases, CCA is performed in units of 20 MHz (at least for 5 GHz).

A wideband operation refers to operation within a channel bandwidth larger than 20 MHz in a shared spectrum. The device can access the shared spectrum for operation based on the outcome of the CCA procedure. The wideband operation comprises of two or more sub-bands. A sub-band is the set of Resource Blocks (RBs) within an approximately 20 MHz segment of the channel where the wideband channel is uniformly divided into an integer number of 20 MHz sub-bands. The sub-bands may be separately allocated in uplink and downlink.

In both scenarios, CCA is performed in units of 20 MHz (e.g. in 5 GHz, 6 GHz etc.). Two modes may be defined according to relationship between the carrier bandwidth (CBW) and the LBT bandwidth (LBW).

In the first mode, multiple carriers are aggregated, and for each carrier the relationship is that CBW=LBT. For the second mode, a single wideband carrier is used and the relationship is CBW>LBW. In the second mode, the wideband carrier therefore consists of multiple “LBT sub-bands” or multiple “LBT bandwidths”. This terminology may be applied generically for both the 5 and 6 GHz bands. For example in 5 GHz or 6 GHz band, in one example LBW=20 MHz. In 5 GHz in some regions the LBW may be smaller e.g. 10 MHz.

3GPP specified the LTE D2D (device-to-device) technology, also known as sidelink (SL) or the PC5 interface, as part of Release 12 (Rel-12). The target use case was the Proximity Services (communication and discovery). Support was enhanced during Rel-13. In Rel-14, the LTE sidelink was extensively redesigned to support vehicular communications (commonly referred to as Vehicle-to-Anything (V2X) or Vehicle-to-Vehicle (V2V)). Support was again enhanced during Rel-15. From the point of view of the lowest radio layers, the LTE SL uses broadcast communication. That is, transmission from a UE targets any receiver that is in range.

In Rel-16, 3GPP introduced sidelink for the 5G new radio (NR). The driving use case was vehicular communications with more stringent requirements than those typically served using the LTE SL. To meet these requirements, the NR SL is capable of broadcast, groupcast, and unicast communications. In groupcast communication, the intended receivers of a message are typically a subset of the vehicles near the transmitter, whereas in unicast communication, there is a single intended receiver. Hybrid Automatic Repeat Request (HARQ) feedback based retransmission is supported for unicast and groupcast.

NR SL introduces 2 stage sidelink control information (SCI), the 1^{st} stage SCI is transmitted on Physical Sidelink Control Channel (PSCCH) and used for the scheduling of Physical Sidelink Shared Channel (PSSCH) and 2^{nd} stage SCI on PSSCH. PSCCH carrying 1^{st} stage SCI and the PSSCH scheduled by the 1^{st} stage SCI are transmitted in the same slot but in different symbols.

NR sidelink transmissions have the following two modes of resource allocations (RA):
Mode 1: Sidelink resources are scheduled by the gNB, including both dynamic scheduling and configured grant.
Mode 2: The UE autonomously selects sidelink resources from a (pre-)configured sidelink resource pool(s) based on the channel sensing mechanism.

For Radio Resource Control (RRC) CONNECTED UE, a UE can be configured to adopt either Resource Allocation (RA) Mode 1 or Mode 2. In other cases, only Mode 2 can be adopted.

As mentioned above, in the 3GPP Rel.18 , a WI on sidelink enhancement has been approved (RP-213678), and one of the objectives is to study and specify support of sidelink on unlicensed spectrum (SL-U). In RAN1 it was agreed that UE to UE COT sharing is supported for SL-U where Type 2 channel access procedure as defined for NR-U can be applied. Furthermore, when a responding UE uses a COT shared by a COT initiating UE for its transmission(s), the COT initiating UE is required to be a target receiver of the responding UE's transmission(s).

One way to meet this requirement is to modify the LCP procedure so that only destinations associated to the COT initiating UEs are considered in LCP. Meanwhile, a UE should not be forced to use a shared COT. In RAN2 the following was agreed in RAN2 #112:

UE can select either to do a changed LCP in order to satisfy the COT requirement, and to do the type-2 LBT, or to do a legacy LCP, and using type-1 or type-2 LBT (i.e., use the COT if that is feasible with the legacy LCP). FFS on spec impact, e.g., conditions for UE to choose either solution.

From the above agreement, it is to further study the detailed conditions based on which the UE can determine to apply either of the two options as follows:
Option 1: UE can select to do a changed LCP in order to satisfy the COT requirement, and to do the type-2 LBT;
Option 2: UE does a legacy LCP, and using type-1 or type- 2 LBT (i.e., use the COT if that is feasible with the legacy LCP).

Some embodiments of the present disclosure will address the conditions for UE to choose which kind of LCP to perform. In some embodiments, conditions for a UE to determine whether a changed LCP or the legacy LCP shall be performed are proposed. Further, in case one kind of LCP is being performed, conditions for a UE to determine whether the UE shall switch to perform another kind of LCP are proposed also.

Therefore, some embodiments of the present disclosure provide one of more of the followings (but not limited to):
Conditions to determine whether a changed LCP shall be performed;
Conditions to determine whether the legacy LCP shall be performed;
Conditions to determine whether to switch to a changed LCP if legacy LCP is currently being performed;
Conditions to determine whether to switch to the legacy LCP if a changed LCP is currently being performed; and
Signaling & procedures to ensure that the obtained resources are (at least partly) within the bandwidth ranges where the COT is shared when a changed LCP is performed.

With some embodiments of the present disclosure, the type of LCP to be performed can be selected/reselected properly and the resources can be obtained properly when a changed LCP is performed in a shared COT, which is crucial for SL operation in unlicensed band.

Some embodiments of the present disclosure are described in the context of NR SL communications in an unlicensed carrier. However, most of the embodiments are in general applicable to any kind of direct communications between UEs involving device-to-device (D2D) communications such as LTE SL in an unlicensed carrier. Embodiments are described from a Transmitter (TX) UE and Receiver (RX) UE point of view. Further, it is assumed that a SL UE and its serving gNB (if the UE is in Network (NW) coverage) operates with the same radio access technology (RAT) e.g., NR, LTE, and so on. However, all the embodiments apply without loss of meaning to any combination of RATs between the SL UE and its serving gNB.

The link or radio link over which the signals are transmitted between at least two UEs for D2D operation may be called herein as the sidelink (SL). The signals transmitted between the UEs for D2D operation may be called herein as SL signals. The term SL may also interchangeably be called as D2D link, V2X link, ProSe link, peer-to-peer link, PC5 link etc. The SL signals may also interchangeably be called as V2X signals, D2D signals, ProSe signals, PC5 signals, peer-to-peer signals etc.

The term LBT may also interchangeably called as clear channel assessment (CCA), shared spectrum access procedure etc. The carrier on which the LBT is applied may belong to a shared spectrum or an unlicensed band or band with contention based access etc. The CCA based operation may be more generally called contention-based operation. The transmission of signals on a carrier subjected to CCA may be also called contention-based transmission. The contention-based operation may be typically used for transmission on carriers of unlicensed frequency band. However this mechanism may also be applied for operating on carriers belonging to licensed band for example to reduce interference. The transmission of signals on a carrier which is not subjected to CCA is also called contention free transmission. LBT or CCA procedure can be performed by UE prior to a transmission and/or by a network node (e.g. base station) prior to a transmission.

Besides, the unlicensed SL carrier can be in any unlicensed band, e.g., 2.5, 5, 6 GHz, Frequency Range 1 (FR1), Frequency Range 2 (FR2), 52.6 GHz to 71 GHz, or beyond 100 GHz.

The following embodiments are applicable to SL transmissions with any cast type including unicast, groupcast, and broadcast. For a SL Bandwidth Part (BWP) configured to the UE, the BWP may contain multiple bandwidth segments referred to as e.g., channel, sub-band, RB set, BWP segment etc., for each segment, it may be configured with the following different parameters:
SubCarrier Spacing (SCS);
Symbol duration;
Cyclic prefix (CP) length.

In this case, the UE may perform LBT operation per channel/subband/RB set/BWP segment.

The term “LBT subband” or “LBT band” used herein may broadly be called as set of physical radio resources or physical radio resource set within a CCA BW i.e. a BW over which the CCA is applied by the UE to access any physical radio resource within that BW. Examples of physical radio resource are time-frequency radio resource etc.

Examples of time-frequency radio resource are RBs, resource elements etc. The embodiments are not limited to any term. Any other similar term e.g., channel, or BWP segment are inter-changeably applicable without losing the meaning.

In the below embodiments, different conditions are defined based on which the UE can determine to apply either of the two options:
Option 1: UE can select to do a changed LCP in order to satisfy the COT requirement, and to do the type-2 LBT;
Option 2: UE does a legacy LCP, and using type-1 or type-2 LBT (i.e., use the COT if that is feasible with the legacy LCP).

In some embodiments, when a UE has been shared or is being shared with a COT from another UE and does not have a built MAC PDU/Transport Block (TB) for a subsequent transmission (either an initial transmission or a retransmission), it may select to apply Option 2 when one or more of the following conditions (Condition 1-X) are satisfied (otherwise Option-1 is applied).

-Condition 1-1: The UE has an ongoing COT. The COT has already gained access to the channel. It means that any UE joining the COT may be only required to perform a Type 2 LBT prior to its transmission.

In some embodiments, the existing COT may be triggered by the UE itself.

In some embodiments, the existing COT may be a COT shared by a third UE. In some embodiments, this third UE may have indicated that the shared COT can be used for transmission to any Layer 2 (L2) destination identifier (ID).

In some embodiments, the condition 1-1 is considered as met only when the existing COT is associated with a Channel Access Priority Class (CAPC) value larger than (or equal to) the CAPC value associated with the shared COT.
Condition 1-2: the UE has an on-going Type 1 LBT process initiated by itself. In this case the UE may select to continue the Type 1 LBT process (i.e., option 2).

In some embodiments, the condition 1-2 is considered as met only when the on-going Type 1 LBT process is associated with a CAPC value larger than (or equal to) the CAPC value associated with the shared COT.
Condition 1-3: the available/obtained resources are not within (or no overlapped with) the bandwidth ranges where the COT is shared.

In some embodiments, the bandwidth ranges shared to the UE may be explicitly indicated in the COT information.

In some embodiments, the bandwidth ranges may be indicated to the UE in an implicit fashion. For example, the bandwidth ranges shared to the UE may be the bandwidth ranges where the transmission carrying the COT information is received by the UE.

In some embodiments, the bandwidth ranges may be expressed as Physical Resource Block (PRB)/subchannel ranges, or a set of resource pools, or part of one or multiple resource pools, or one or multiple LBT subbands/BWPs.

In some embodiments, the resources may be obtained by the UE via either Resource Allocation Mode 1 or Resource Allocation Mode 2.
Condition 1-4: Upon reception of the COT information, the UE may or may not have already obtained/reserved some resources for subsequent transmissions. At least one of the below sub-conditions may also be considered.

In some embodiments, if the UE has already obtained at least one resource for subsequent transmission, the time gap between the time when the COT information is received (or the time positions indicated in the COT information from which the UE can use the shared COT for its transmission) and the time when the first resource is to be occurred is equal to or larger than a threshold. In some embodiments, the threshold may be configured (e.g., by the network) or preconfigured to the UE.

In some embodiments, if the resource selection and reselection is still on-going (in case of Resource Allocation Mode 2), the time gap between the time when the COT information is received (or the time positions indicated in the COT information from which the UE can use the shared COT for its transmission) and the start time of the resource selection window is equal to or larger than a threshold. The threshold may be configured (e.g., by the network) or preconfigured to the UE.

The intention of the condition is that when the time gap is large enough, the UE is able to finish the Type 1 LBT operation before the obtained/reserved resource, and thus there is no need to apply Option 1. The threshold could be configured or preconfigured depending on the measured congestion (e.g., measured in terms of Channel Busy Ratio (CBR)) in the shared bandwidth ranges. The higher the measured congestion is, the larger threshold is.
Condition 1-5: the UE's intended transmission towards the COT initiating UE has CAPC value larger than the CAPC value associated with the shared COT.

In some embodiments, the CAPC value of the intended transmission can be determined based on the PC5 5^{th} Generation (5G) Quality of Service (QoS) Indicator (PQI) associated to the traffic pending to be transmitted to the COT initiating UE.

In some embodiments, the condition 1-5 is considered as met if the transmission contains only MAC Control Element(s) (CE(s)) (which could happen if the UE has only MAC CE(s) triggered.

On the contrary, in some embodiments, the UE may apply Option 1 when one or more of the following conditions (Condition 2-X) are satisfied (otherwise Option 2 is applied):
Condition 2-1: One or more of the conditions 1-1 to the condition 1-3 are not met.
Condition 2-2: In case the UE has already obtained at least one resource for subsequent transmission, the time gap between the time when the COT information is received (or the time positions indicated in the COT information from which the UE can use the shared COT for its transmission) and the time when the first resource is to be occurred is equal to or smaller than a threshold. In some embodiments, the threshold may be configured (e.g., by the network) or preconfigured to the UE.
Condition 2-3: In case the resource selection and reselection is still on-going (in case of Resource Allocation Mode 2), the time gap between the time when the COT information is received (or the time positions indicated in the COT information from which the UE can use the shared COT for its transmission) and the start time of the resource selection window is equal to or smaller than a threshold. In some embodiments, the threshold may be configured (e.g., by the network) or preconfigured to the UE.
Condition 2-4: The UE has pending traffic to be transmitted where the UE sharing the COT is a target receiver of the pending traffic. How a UE determining whether another UE is a target receiver of its transmission is described in the international PCT application, “PCT/CN2022/120962”, which is incorporated herein by reference in its entirety.
This condition may only be considered as met when the pending traffic has CAPC value (determined based on PQI of the pending traffic) smaller than or equal to the CAPC value associated with the shared COT.

In some embodiments, in case a UE has applied option 2 to build a MAC PDU and is shared with a COT from another UE before the MAC PDU is transmitted (i.e., the UE has performed the legacy LCP but has not performed or has not finished the LBT process), the UE may perform any of the followings after being shared with the COT:
The UE always does not switch to apply option 1, i.e., does not re-perform the changed LCP, and performs LBT according to option 2.
The UE always switches to apply option 1, i.e., re-performs the modified LCP (which may result in a new MAC PDU being built) and performs type 2 LBT. Type 1 LBT may be stopped if it is already started.
The UE does not switch to apply option 1 if the one or more of the conditions (e.g., the conditions 1-1 through 1-5) described in the above embodiments based on which the UE determines whether option 2 shall be applied are met.
The UE switches to apply option 1 if the one or more of the conditions (e.g., the conditions 2-1 through 2-4) described in the above embodiments based on which the UE determines whether option 1 shall be applied are met.

In some embodiments, in case the UE has already been shared with a COT and applied option 1 in the shared COT, the UE may switch to apply option 2 if any one or more of the following conditions are satisfied:
The COT is ended and can no more be used.
The UE has no more traffic to be transmitted where the UE sharing the COT is a target receiver of the traffic.
There is new traffic arrived at the UE where the UE sharing the COT is not a target receiver of the traffic, and the new arrived traffic has higher priority than that of the traffic where the UE sharing the COT is a target receiver.
The CAPC value of the traffic where the UE sharing the COT is a target receiver is larger than the CAPC value of the COT.
The available/obtained resources are not within (or no overlapped with) the bandwidth ranges where the COT is shared.

In some embodiments, in case the UE is shared with a COT and applying option 1 (i.e., performing changed LCP), while the resources obtained via Resource Allocation Mode 1 or Resource Allocation Mode 2 are not within the bandwidth ranges where the COT is shared, the UE may perform any of the followings:
In case of Resource Allocation Mode 1, the UE may inform the gNB of any one or more of the followings:
   The granted resources cannot be used;
   The corresponding cause, e.g., the resources are not within the bandwidth ranges of a shared COT;
   The bandwidth ranges in which the UE expects to be granted with resources, optionally also the duration within which the UE expects to be granted with resources in the indicated bandwidth ranges.

In some embodiments, the gNB may then grant resources in the indicated bandwidth ranges within the indicated duration to the UE.

In some embodiments, in case the gNB does not grant resources in the indicated bandwidth ranges within the indicated duration, the UE may abort to apply option 1 and switch to apply option 2, which implies the UE will not use the shared COT in this case.
In case of Resource Allocation Mode 2, the MAC layer in the UE may trigger a resource reselection, the MAC layer may inform the physical layer of the bandwidth ranges in which the resources shall be reselected, optionally also the duration within which the resources shall be reselected in the bandwidth ranges. In some embodiments, the physical layer may then reselect resources in the informed bandwidth ranges within the informed duration.

With some embodiments of the present disclosure, the type of LCP to be performed can be selected/reselected properly and the resources can be obtained properly when a changed LCP is performed in a shared COT, which is crucial for SL operation in unlicensed band.

FIG. 2 is a flow chart illustrating an exemplary method 200 at a UE for LCP procedure selection according to an embodiment of the present disclosure. The method 200 may be performed at a UE (e.g., the UE 100-1 or the UE 100-2). The method 200 may comprise steps S210 and S220. However, the present disclosure is not limited thereto. In some other embodiments, the method 200 may comprise more steps, less steps, different steps, or any combination thereof. Further the steps of the method 200 may be performed in a different order than that described herein when multiple steps are involved. Further, in some embodiments, a step in the method 200 may be split into multiple sub-steps and performed by different entities, and/or multiple steps in the method 200 may be combined into a single step.

The method 200 may begin at step S210 where a first message indicating first COT information for sharing a first COT with the UE may be received from a second UE. At step S220, a first LCP procedure or a second LCP procedure may be selected based on one or more selection conditions in response to receiving the first message.

In some embodiments, a Logical Channel (LCH) may be considered in the first LCP procedure only when it has a destination associated with the second UE. In some embodiments, an LCH may be considered in the second LCP procedure no matter whether it has a destination associated with the second UE or not. In some embodiments, the UE may have not started a LCP procedure to build a MAC PDU and/or a TB for subsequent transmission.

In some embodiments, the one or more selection conditions may comprise at least one of: whether the UE has a second COT that is ongoing and has already gained access to its corresponding channel; whether the UE has an ongoing Type-1 LBT procedure initiated by the UE itself; whether one or more radio resources available to the UE and/or one or more radio resources obtained by the UE are within and/or overlapped with one or more bandwidth ranges where the first COT is shared; whether a time gap between the time when the first COT information is received or the first COT is allowed to be shared and the time of the earliest radio resource that the UE has obtained or has potential to be obtained for subsequent transmission is less than, equal to, or greater than a threshold; whether the UE's intended transmission towards the second UE has a CAPC value greater than a CAPC value associated with the first COT; and whether the UE has pending traffic to be transmitted where the second UE is a target receiver of the pending traffic.

In some embodiments, the step of selecting a first LCP procedure or a second LCP procedure may comprise at least one of: selecting the first LCP procedure in response to determining that the UE does not have a second COT that is ongoing and has already gained access to its corresponding channel; and selecting the second LCP procedure in response to determining that the UE has a second COT that is ongoing and has already gained access to its corresponding channel. In some embodiments, the second COT may be triggered by the UE itself. In some embodiments, the second COT may be shared by a third UE. In some embodiments, the second COT may be able to be used for transmission to any L2 destination ID. In some embodiments, before the step of selecting a first LCP procedure or a second LCP procedure, the method 200 may further comprise: determining whether the second COT is associated with a CAPC value greater than or equal to the CAPC value associated with the first COT, wherein the step of selecting a first LCP procedure or a second LCP procedure may further comprise at least one of: selecting the first LCP procedure in response to determining that the second COT is not associated with a CAPC value greater than or equal to the CAPC value associated with the first COT; and selecting the second LCP procedure in response to determining that the second COT is associated with a CAPC value greater than or equal to the CAPC value associated with the first COT.

In some embodiments, the step of selecting a first LCP procedure or a second LCP procedure may comprise at least one of: selecting the first LCP procedure in response to determining that the UE does not have an ongoing Type-1 LBT procedure initiated by the UE itself; and selecting the second LCP procedure in response to determining that the UE has an ongoing Type-1 LBT procedure initiated by the UE itself. In some embodiments, before the step of selecting a first LCP procedure or a second LCP procedure, the method 200 may further comprise: determining whether the ongoing Type-1 LBT procedure is associated with a CAPC value greater than or equal to the CAPC value associated with the first COT, wherein the step of selecting a first LCP procedure or a second LCP procedure further may comprise at least one of: selecting the first LCP procedure in response to determining that the ongoing Type-1 LBT procedure is not associated with a CAPC value greater than or equal to the CAPC value associated with the first COT; and selecting the second LCP procedure in response to determining that the ongoing Type-1 LBT procedure is associated with a CAPC value greater than or equal to the CAPC value associated with the first COT.

In some embodiments, the step of selecting a first LCP procedure or a second LCP procedure may comprise at least one of: selecting the first LCP procedure in response to determining that at least one of the one or more radio resources available to the UE and/or at least one of the one or more radio resources obtained by the UE are within and/or overlapped with at least one of the one or more bandwidth ranges where the first COT is shared; and selecting the second LCP procedure in response to determining that the one or more radio resources available to the UE and/or the one or more radio resources obtained by the UE are not within and/or overlapped with the one or more bandwidth ranges where the first COT is shared. In some embodiments, at least one of the one or more bandwidth ranges may be indicated by at least one of: one or more PRB ranges; one or more sub-channel ranges; a set of resource pools; a part of one or more resource pools; one or more LBT sub-bands; and one or more LBT BWPs. In some embodiments, the one or more radio resources may be obtained by the UE via at least one of: Resource Allocation Mode 1; and Resource Allocation Mode 2.

In some embodiments, the step of selecting a first LCP procedure or a second LCP procedure may comprise at least one of: selecting the first LCP procedure in response to determining that the time gap between the time when the first COT information is received and the time of the earliest radio resource that is obtained for the subsequent transmission is equal to or less than a first threshold; selecting the second LCP procedure in response to determining that the time gap between the time when the first COT information is received and the time of the earliest radio resource that is obtained for the subsequent transmission is equal to or greater than the first threshold; selecting the first LCP procedure in response to determining that the time gap between the time when the first COT is allowed to be shared and the time of the earliest radio resource that is obtained for the subsequent transmission is equal to or less than a second threshold; selecting the second LCP procedure in response to determining that the time gap between the time when the first COT is allowed to be shared and the time of the earliest radio resource that is obtained for the subsequent transmission is equal to or greater than the second threshold; selecting the first LCP procedure in response to determining that the time gap between the time when the first COT information is received and the time of the earliest radio resource that has potential to be obtained is equal to or less than a third threshold; selecting the second LCP procedure in response to determining that the time gap between the time when the first COT information is received and the time of the earliest radio resource that has potential to be obtained is equal to or greater than the third threshold; selecting the first LCP procedure in response to determining that the time gap between the time when the first COT is allowed to be shared and the time of the earliest radio resource that has potential to be obtained is equal to or less than a fourth threshold; and selecting the second LCP procedure in response to determining that the time gap between the time when the first COT is allowed to be shared and the time of the earliest radio resource that has potential to be obtained is equal to or greater than the fourth threshold. In some embodiments, at least one of the first threshold, the second threshold, the third threshold, and the fourth threshold may be configured or preconfigured to the UE based on at least a measured congestion level in one or more bandwidth ranges where the first COT is shared. In some embodiments, at least one of the first threshold, the second threshold, the third threshold, and the fourth threshold may be configured or preconfigured to be greater when the measured congestion level is higher.

In some embodiments, the step of selecting a first LCP procedure or a second LCP procedure may comprise at least one of: selecting the first LCP procedure in response to determining that the UE's intended transmission towards the second UE does not have a CAPC value greater than the CAPC value associated with the first COT; and selecting the second LCP procedure in response to determining that the UE's intended transmission towards the second UE has a CAPC value greater than the CAPC value associated with the first COT. In some embodiments, the CAPC value of the UE's intended transmission towards the second UE may be determined based on at least a PQI associated with traffic pending to be transmitted to the second UE. In some embodiments, before the step of selecting a first LCP procedure or a second LCP procedure, the method 200 may further comprise: determining whether the UE's intended transmission towards the second UE comprises only MAC CEs or not, wherein the step of selecting a first LCP procedure or a second LCP procedure may comprise: selecting the second LCP procedure in response to determining that the UE's intended transmission towards the second UE comprises only MAC CEs.

In some embodiments, the step of selecting a first LCP procedure or a second LCP procedure may comprise at least one of: selecting the first LCP procedure in response to determining that the UE has pending traffic to be transmitted where the second UE is a target receiver of the pending traffic; and selecting the second LCP procedure in response to determining that the UE does not have pending traffic to be transmitted where the second UE is a target receiver of the pending traffic. In some embodiments, before the step of selecting a first LCP procedure or a second LCP procedure, the method 200 may further comprise: determining whether the pending traffic has a CAPC value, which is determined based on a PQI of the pending traffic, less than or equal to a CAPC value associated with the first COT; wherein the step of selecting a first LCP procedure or a second LCP procedure may comprise at least one of: selecting the first LCP procedure in response to determining that the pending traffic has a CAPC value, which is determined based on the PQI of the pending traffic, less than or equal to the CAPC value associated with the first COT; and selecting the second LCP procedure in response to determining that the pending traffic does not have a CAPC value, which is determined based on the PQI of the pending traffic, less than or equal to the CAPC value associated with the first COT. In some embodiments, the selected LCP procedure may be performed for SL communication.

FIG. 3 is a flow chart illustrating an exemplary method 300 at a UE for LCP procedure reselection according to an embodiment of the present disclosure. The method 300 may be performed at a UE (e.g., the UE 100-1 or the UE 100-2). The method 300 may comprise steps S310, S320, and S330. However, the present disclosure is not limited thereto. In some other embodiments, the method 300 may comprise more steps, less steps, different steps, or any combination thereof. Further the steps of the method 300 may be performed in a different order than that described herein when multiple steps are involved. Further, in some embodiments, a step in the method 300 may be split into multiple sub-steps and performed by different entities, and/or multiple steps in the method 300 may be combined into a single step.

The method 300 may begin at step S310 where one of a first LCP procedure and a second LCP procedure may be selected to build a first MAC PDU.

At step S320, a first message indicating first COT information for sharing a first COT with the UE may be received from a second UE.

At step S330, whether the other of the first LCP procedure and the second LCP procedure is to be reselected may be determined in response to receiving the first message.

In some embodiments, an LCH may be considered in the first LCP procedure only when it has a destination associated with the second UE. In some embodiments, an LCH may be considered in the second LCP procedure no matter whether it has a destination associated with the second UE or not.

In some embodiments, the step of selecting one of a first LCP procedure and a second LCP procedure to build a first MAC PDU may comprise: selecting the second LCP procedure to build the first MAC PDU, wherein the step of receiving the first message is performed before the first MAC PDU is transmitted and/or before an LBT procedure for transmitting the first MAC PDU has been performed or finished. In some embodiments, the step of determining whether the other of the first LCP procedure and the second LCP procedure is to be reselected may comprise at least one of: determining that the first LCP procedure is always to be not reselected; determining that the first LCP procedure is always to be reselected; and determining whether the first LCP procedure is to be reselected or not based on one or more first reselection conditions.

In some embodiments, when it is determined that the first LCP procedure is always to be reselected, the method 300 may further comprise at least one of: stopping the LBT procedure for transmitting the first MAC PDU; performing the first LCP procedure to build a second MAC PDU; and performing a type-2 LBT procedure for transmitting the second MAC PDU. In some embodiments, the one or more first reselection conditions may comprise at least one of: whether the UE has a second COT that is ongoing and has already gained access to its corresponding channel; whether the UE has an ongoing Type-1 LBT procedure initiated by the UE itself; whether one or more radio resources available to the UE and/or one or more radio resources obtained by the UE are within and/or overlapped with one or more bandwidth ranges where the first COT is shared; whether a time gap between the time when the first COT information is received or the first COT is allowed to be shared and the time of the earliest radio resource that the UE has obtained or has potential to be obtained for subsequent transmission is less than, equal to, or greater than a threshold; whether the UE's intended transmission towards the second UE has a CAPC value greater than a CAPC value associated with the first COT; and whether the UE has pending traffic to be transmitted where the second UE is a target receiver of the pending traffic.

In some embodiments, the step of determining whether the first LCP procedure is to be reselected or not may comprise at least one of: determining that the first LCP procedure is to be reselected in response to determining that the UE does not have a second COT that is ongoing and has already gained access to its corresponding channel; and determining that the first LCP procedure is not to be reselected in response to determining that the UE has a second COT that is ongoing and has already gained access to its corresponding channel. In some embodiments, the second COT may be triggered by the UE itself. In some embodiments, the second COT may be shared by a third UE. In some embodiments, the second COT may be able to be used for transmission to any L2 destination ID.

In some embodiments, before the step of determining whether the first LCP procedure is to be reselected or not, the method 300 may further comprise: determining whether the second COT is associated with a CAPC value greater than or equal to the CAPC value associated with the first COT, wherein the step of determining whether the first LCP procedure is to be reselected or not may further comprise at least one of: determining that the first LCP procedure is to be reselected in response to determining that the second COT is not associated with a CAPC value greater than or equal to the CAPC value associated with the first COT; and determining that the first LCP procedure is not to be reselected in response to determining that the second COT is associated with a CAPC value greater than or equal to the CAPC value associated with the first COT.

In some embodiments, the step of determining whether the first LCP procedure is to be reselected or not may comprise at least one of: determining that the first LCP procedure is to be reselected in response to determining that the UE does not have an ongoing Type-1 LBT procedure initiated by the UE itself; and determining that the first LCP procedure is not to be reselected in response to determining that the UE has an ongoing Type-1 LBT procedure initiated by the UE itself. In some embodiments, before the step of determining whether the first LCP procedure is to be reselected or not, the method 300 may further comprise: determining whether the ongoing Type-1 LBT procedure is associated with a CAPC value greater than or equal to the CAPC value associated with the first COT, wherein the step of determining whether the first LCP procedure is to be reselected or not may further comprise at least one of: determining that the first LCP procedure is to be reselected in response to determining that the ongoing Type-1 LBT procedure is not associated with a CAPC value greater than or equal to the CAPC value associated with the first COT; and determining that the first LCP procedure is not to be reselected in response to determining that the ongoing Type-1 LBT procedure is associated with a CAPC value greater than or equal to the CAPC value associated with the first COT.

In some embodiments, the step of determining whether the first LCP procedure is to be reselected or not may comprise at least one of: determining that the first LCP procedure is to be reselected in response to determining that at least one of the one or more radio resources available to the UE and/or at least one of the one or more radio resources obtained by the UE are within and/or overlapped with at least one of the one or more bandwidth ranges where the first COT is shared; and determining that the first LCP procedure is not to be reselected in response to determining that the one or more radio resources available to the UE and/or the one or more radio resources obtained by the UE are not within and/or overlapped with the one or more bandwidth ranges where the first COT is shared. In some embodiments, at least one of the one or more bandwidth ranges may be indicated by at least one of: one or more PRB ranges; one or more sub-channel ranges; a set of resource pools; a part of one or more resource pools; one or more LBT sub-bands; and one or more LBT BWPs. In some embodiments, the one or more radio resources may be obtained by the UE via at least one of: Resource Allocation Mode 1; and Resource Allocation Mode 2.

In some embodiments, the step of determining whether the first LCP procedure is to be reselected or not may comprise at least one of: determining that the first LCP procedure is to be reselected in response to determining that the time gap between the time when the first COT information is received and the time of the earliest radio resource that is obtained for the subsequent transmission is equal to or less than a first threshold; determining that the first LCP procedure is not to be reselected in response to determining that the time gap between the time when the first COT information is received and the time of the earliest radio resource that is obtained for the subsequent transmission is equal to or greater than the first threshold; determining that the first LCP procedure is to be reselected in response to determining that the time gap between the time when the first COT is allowed to be shared, and the time of the earliest radio resource that is obtained for the subsequent transmission is equal to or less than a second threshold; determining that the first LCP procedure is not to be reselected in response to determining that a time gap between the time when the first COT is allowed to be shared, and the time of the earliest radio resource that is obtained for the subsequent transmission is equal to or greater than the second threshold; selecting the first LCP procedure in response to determining that the time gap between the time when the first COT information is received and the time of the earliest radio resource that has potential to be obtained is equal to or less than a third threshold; selecting the second LCP procedure in response to determining that the time gap between the time when the first COT information is received and the time of the earliest radio resource that has potential to be obtained is equal to or greater than the third threshold; selecting the first LCP procedure in response to determining that the time gap between the time when the first COT is allowed to be shared and the time of the earliest radio resource that has potential to be obtained is equal to or less than a fourth threshold; and selecting the second LCP procedure in response to determining that the time gap between the time when the first COT is allowed to be shared and the time of the earliest radio resource that has potential to be obtained is equal to or greater than the fourth threshold. In some embodiments, at least one of the first threshold, the second threshold, the third threshold, and the fourth threshold may be configured or preconfigured to the UE based on at least a measured congestion level in one or more bandwidth ranges where the first COT is shared. In some embodiments, at least one of the first threshold, the second threshold, the third threshold, and the fourth threshold may be configured or preconfigured to be greater when the measured congestion level is higher.

In some embodiments, the step of determining whether the first LCP procedure is to be reselected or not may comprise at least one of: determining that the first LCP procedure is to be reselected in response to determining that the UE's intended transmission towards the second UE does not have a CAPC value greater than the CAPC value associated with the first COT; and determining that the first LCP procedure is not to be reselected in response to determining that the UE's intended transmission towards the second UE has a CAPC value greater than the CAPC value associated with the first COT. In some embodiments, the CAPC value of the UE's intended transmission towards the second UE may be determined based on at least a PQI associated with traffic pending to be transmitted to the second UE. In some embodiments, before the step of determining whether the first LCP procedure is to be reselected or not, the method 300 may further comprise: determining whether the UE's intended transmission towards the second UE comprises only MAC CEs or not, wherein the step of determining whether the first LCP procedure is to be reselected or not may comprise: determining that the first LCP procedure is not to be reselected in response to determining that the UE's intended transmission towards the second UE comprises only MAC CES.

In some embodiments, the step of determining whether the first LCP procedure is to be reselected or not may comprise at least one of: determining that the first LCP procedure is to be reselected in response to determining that the UE has pending traffic to be transmitted where the second UE is a target receiver of the pending traffic; and determining that the first LCP procedure is not to be reselected in response to determining that the UE does not have pending traffic to be transmitted where the second UE is a target receiver of the pending traffic. In some embodiments, before the step of determining whether the first LCP procedure is to be reselected or not, the method 300 may further comprise: determining whether the pending traffic has a CAPC value, which is determined based on a PQI of the pending traffic, less than or equal to a CAPC value associated with the first COT; wherein the step of determining whether the first LCP procedure is to be reselected or not may comprise at least one of: determining that the first LCP procedure is to be reselected in response to determining that the pending traffic has a CAPC value, which is determined based on the PQI of the pending traffic, less than or equal to the CAPC value associated with the first COT; and determining that the first LCP procedure is not to be reselected in response to determining that the pending traffic does not have a CAPC value, which is determined based on the PQI of the pending traffic, less than or equal to the CAPC value associated with the first COT.

In some embodiments, the step of selecting one of a first LCP procedure and a second LCP procedure to build a first MAC PDU may comprise: selecting the first LCP procedure to build the first MAC PDU. In some embodiments, the step of determining whether the other of the first LCP procedure and the second LCP procedure is to be reselected may comprise at least one of: determining whether the second LCP procedure is to be reselected or not based on one or more second reselection conditions. In some embodiments, the one or more second reselection conditions may comprise at least one of: whether the first COT is ended or not; whether the UE has traffic to be transmitted, for which the second UE is a target receiver of the traffic; whether there is new traffic arrived at the UE where the second UE is not a target receiver of the new traffic and/or determining whether the new traffic has a higher priority than that of the traffic where the second UE is a target receiver; whether a CAPC value associated with the traffic where the second UE is a target receiver is greater than the CAPC value associated with the first COT; and whether one or more radio resources available to the UE and/or one or more radio resources obtained by the UE are within and/or overlapped with one or more bandwidth ranges where the first COT is shared.

In some embodiments, the step of determining whether the second LCP procedure is to be reselected or not may comprise at least one of: determining that the second LCP procedure is to be reselected in response to determining that the first COT is ended; and determining that the second LCP procedure is not to be reselected in response to determining that the first COT is not ended.

In some embodiments, the step of determining whether the second LCP procedure is to be reselected or not may comprise at least one of: determining that the second LCP procedure is to be reselected in response to determining that the UE has no traffic to be transmitted, for which the second UE is a target receiver; and determining that the second LCP procedure is not to be reselected in response to determining that the UE has traffic to be transmitted, for which the second UE is a target receiver.

In some embodiments, the step of determining whether the second LCP procedure is to be reselected or not may comprise at least one of: determining that the second LCP procedure is to be reselected in response to determining that there is new traffic arrived at the UE where the second UE is not a target receiver of the new traffic and determining that the new traffic has a higher priority than that of the traffic where the second UE is a target receiver; and determining that the second LCP procedure is not to be reselected in response to determining that there is no new traffic arrived at the UE where the second UE is not a target receiver of the new traffic and/or determining that the new traffic does not have a higher priority than that of the traffic where the second UE is a target receiver.

In some embodiments, the step of determining whether the second LCP procedure is to be reselected or not may comprise at least one of: determining that the second LCP procedure is to be reselected in response to determining that the CAPC value associated with the traffic where the second UE is a target receiver is greater than the CAPC value associated with the first COT; and determining that the second LCP procedure is not to be reselected in response to determining that the CAPC value associated with the traffic where the second UE is a target receiver is not greater than the CAPC value associated with the first COT.

In some embodiments, the step of determining whether the second LCP procedure is to be reselected or not may comprise at least one of: determining that the second LCP procedure is to be reselected in response to determining that the one or more radio resources available to the UE and/or the one or more radio resources obtained by the UE are not within and/or overlapped with the one or more bandwidth ranges where the first COT is shared; and determining that the second LCP procedure is not to be reselected in response to determining that at least one of the one or more radio resources available to the UE and/or at least one of the one or more radio resources obtained by the UE are within and/or overlapped with at least one of the one or more bandwidth ranges where the first COT is shared.

In some embodiments, the selected LCP procedure and/or the reselected LCP procedure may be performed for SL communication.

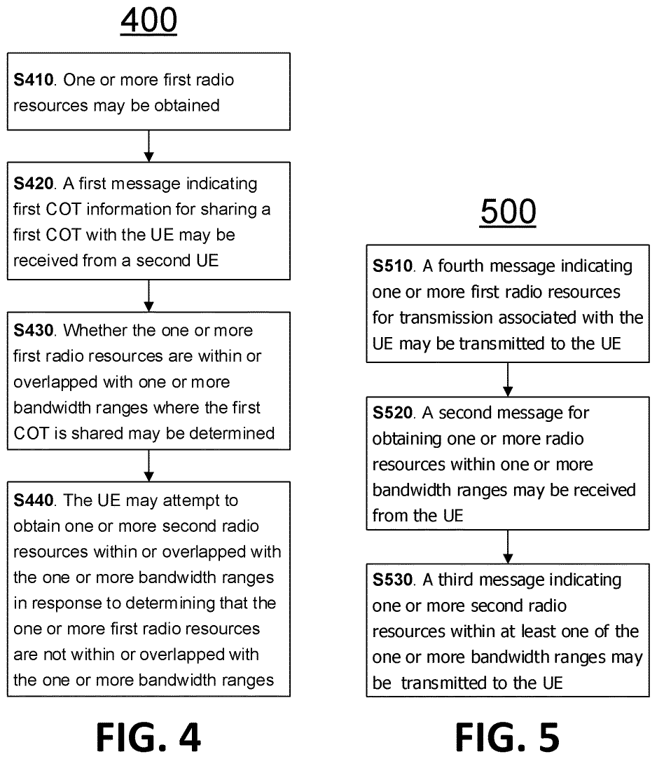

FIG. 4 is a flow chart illustrating an exemplary method 400 at a UE for radio resource management according to an embodiment of the present disclosure. The method 400 may be performed at a UE (e.g., the UE 100-1 or the UE 100-2). The method 400 may comprise steps S410, S420, S430, and S440. However, the present disclosure is not limited thereto. In some other embodiments, the method 400 may comprise more steps, less steps, different steps, or any combination thereof. Further the steps of the method 400 may be performed in a different order than that described herein when multiple steps are involved. Further, in some embodiments, a step in the method 400 may be split into multiple sub-steps and performed by different entities, and/or multiple steps in the method 400 may be combined into a single step.

The method 400 may begin at step S410 where one or more first radio resources may be obtained.

At step S420, a first message indicating first COT information for sharing a first COT with the UE may be received from a second UE.

At step S430, whether the one or more first radio resources are within or overlapped with one or more bandwidth ranges where the first COT is shared may be determined.

At step S440, the UE may attempt to obtain one or more second radio resources within or overlapped with the one or more bandwidth ranges in response to determining that the one or more first radio resources are not within or overlapped with the one or more bandwidth ranges.

In some embodiments, the method 400 may further comprise: performing a first LCP procedure in response to receiving the first message, wherein an LCH may be considered in the first LCP procedure only when it has a destination associated with the second UE.

In some embodiments, when the one or more first radio resources are obtained from a network node via Resource Allocation Mode 1, the step of attempting to obtain one or more second radio resources may comprise: transmitting, to the network node, a second message for obtaining one or more radio resources within at least one of the one or more bandwidth ranges. In some embodiments, the second message may indicate at least one of: that the one or more first radio resources cannot be used; a cause indicating that the one or more first radio resources are not within or overlapped with the one or more bandwidth ranges; at least one of the one or more bandwidth ranges in which the UE expects to be granted with radio resources; and a duration within which the UE expects to be granted with one or more radio resources in at least one of the one or more bandwidth ranges. In some embodiments, the step of attempting to obtain one or more second radio resources may further comprise: receiving, from the network node, a third message indicating the one or more second radio resources within at least one of the one or more bandwidth ranges.

In some embodiments, in response to determining that no radio resource within or overlapped with the one or more bandwidth ranges is obtained within a duration indicated by the second message, the method 400 may further comprise: aborting the first LCP procedure; and performing a second LCP procedure, wherein an LCH may be considered in the second LCP procedure no matter whether it has a destination associated with the second UE or not.

In some embodiments, when the one or more first radio resources are obtained via Resource Allocation Mode 2, the step of attempting to obtain one or more second radio resources may comprise: informing, from the MAC layer to the Physical layer, one or more bandwidth ranges in which radio resources are to be reselected; and reselecting the one or more second radio resources within the one or more bandwidth ranges. In some embodiments, in addition to informing the one or more bandwidth ranges, a duration within which the radio resources are to be reselected in the one or more bandwidth ranges may also be informed from the MAC layer to the Physical layer, wherein the step of reselecting the one or more second radio resources within the one or more bandwidth ranges may comprise: reselecting the one or more second radio resources within the one or more bandwidth ranges within the informed duration. In some embodiments, the one or more first radio resources and/or the one or more second radio resources may be used for SL communication.

FIG. 5 is a flow chart illustrating an exemplary method 500 at a network node for facilitating a UE in radio resource management according to an embodiment of the present disclosure. The method 500 may be performed at a network node (e.g., the gNB 105). The method 500 may comprise steps S510, S520, and S530. However, the present disclosure is not limited thereto. In some other embodiments, the method 500 may comprise more steps, less steps, different steps, or any combination thereof.

Further the steps of the method 500 may be performed in a different order than that described herein when multiple steps are involved. Further, in some embodiments, a step in the method 500 may be split into multiple sub-steps and performed by different entities, and/or multiple steps in the method 500 may be combined into a single step.

The method 500 may begin at step S510 where a fourth message indicating one or more first radio resources for transmission associated with the UE may be transmitted to the UE.

At step S520, a second message for obtaining one or more radio resources within one or more bandwidth ranges may be received from the UE.

At step S530, a third message indicating one or more second radio resources within at least one of the one or more bandwidth ranges may be transmitted to the UE. In some embodiments, the second message may indicate at least one of: that the one or more first radio resources cannot be used; a cause indicating that the one or more first radio resources are not within or overlapped with the one or more bandwidth ranges; at least one of the one or more bandwidth ranges in which the UE expects to be granted with radio resources; and a duration within which the UE expects to be granted with one or more radio resources in at least one of the one or more bandwidth ranges. In some embodiments, the fourth message may be a message used in Resource Allocation Mode 1 for allocating the one or more first radio resources to the UE. In some embodiments, the one or more bandwidth ranges may be one or more bandwidth ranges where a first COT is shared by a second UE with the UE. In some embodiments, the one or more first radio resources and/or the one or more second radio resources may be used for SL communication.

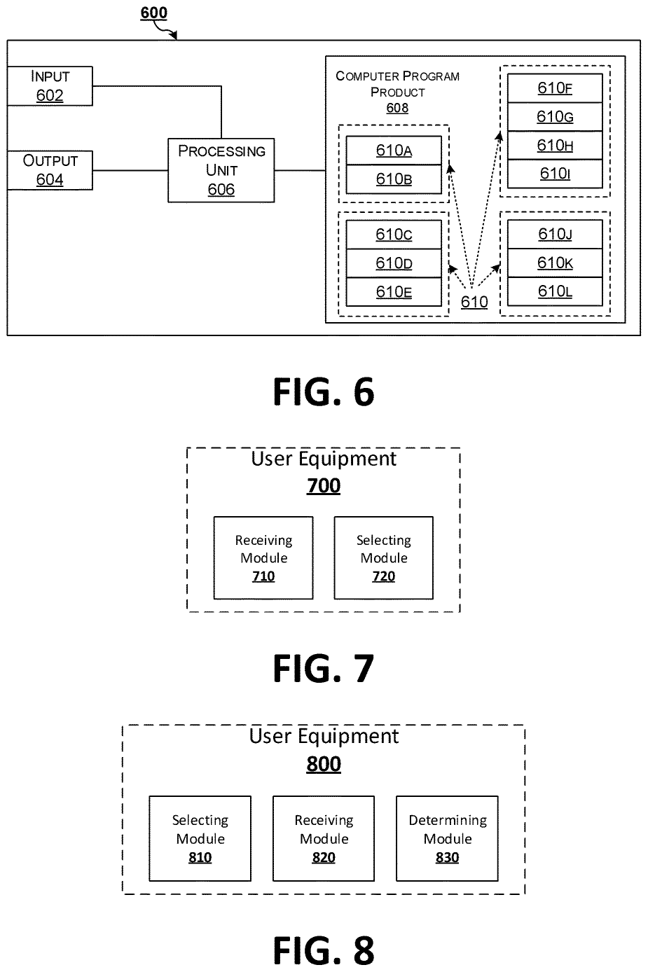

FIG. 6 schematically shows an embodiment of an arrangement 600 which may be used in UEs (e.g., the UE 100-1 or the UE 100-2) or a network node (e.g., the gNB 105) according to an embodiment of the present disclosure. Comprised in the arrangement 600 are a processing unit 606, e.g., with a Digital Signal Processor (DSP) or a Central Processing Unit (CPU). The processing unit 606 may be a single unit or a plurality of units to perform different actions of procedures described herein. The arrangement 600 may also comprise an input unit 602 for receiving signals from other entities, and an output unit 604 for providing signal(s) to other entities. The input unit 602 and the output unit 604 may be arranged as an integrated entity or as separate entities.

Furthermore, the arrangement 600 may comprise at least one computer program product 608 in the form of a non-volatile or volatile memory, e.g., an Electrically Erasable Programmable Read-Only Memory (EEPROM), a flash memory and/or a hard drive. The computer program product 608 comprises a computer program 610, which comprises code/computer readable instructions, which when executed by the processing unit 606 in the arrangement 600 causes the arrangement 600 and/or the UE/network node in which it is comprised to perform the actions, e.g., of the procedure described earlier in conjunction with FIG. 2 through FIG. 5 or any other variant.

The computer program 610 may be configured as a computer program code structured in computer program modules 610A and 610B. Hence, in an exemplifying embodiment when the arrangement 600 is used in a UE for LCP procedure selection, the code in the computer program of the arrangement 600 includes: a module 610A configured to receive, from a second UE, a first message indicating first COT information for sharing a first COT with the UE; and a module 610B configured to select a first LCP procedure or a second LCP procedure based on one or more selection conditions in response to receiving the first message.

Additionally or alternatively, the computer program 610 may be further configured as a computer program code structured in computer program modules 610C, 610D, and 610E. Hence, in an exemplifying embodiment when the arrangement 600 is used in a UE for LCP procedure reselection, the code in the computer program of the arrangement 600 includes: a module 610C configured to select one of a first LCP procedure and a second LCP procedure to build a first MAC PDU; a module 610D configured to receive, from a second UE, a first message indicating first COT information for sharing a first COT with the UE; and a module 610E configured to determine whether the other of the first LCP procedure and the second LCP procedure is to be reselected in response to receiving the first message.

Additionally or alternatively, the computer program 610 may be further configured as a computer program code structured in computer program modules 610F, 610G, 610H, and 610I. Hence, in an exemplifying embodiment when the arrangement 600 is used in a UE for radio resource management, the code in the computer program of the arrangement 600 includes: a module 610F configured to obtain one or more first radio resources; a module 610G configured to receive, from a second UE, a first message indicating first COT information for sharing a first COT with the UE; a module 610H configured to determine whether the one or more first radio resources are within or overlapped with one or more bandwidth ranges where the first COT is shared; and a module 610I configured to attempt to obtain one or more second radio resources within or overlapped with the one or more bandwidth ranges in response to determining that the one or more first radio resources are not within or overlapped with the one or more bandwidth ranges.

Additionally or alternatively, the computer program 610 may be further configured as a computer program code structured in computer program modules 610J, 610K, and 610L. Hence, in an exemplifying embodiment when the arrangement 600 is used in a network node for facilitating a UE in radio resource management, the code in the computer program of the arrangement 600 includes: a module 610J configured to transmit, to the UE, a fourth message indicating one or more first radio resources for transmission associated with the UE; a module 610K configured to receive, from the UE, a second message for obtaining one or more radio resources within one or more bandwidth ranges; and a module 610L configured to transmit, to the UE, a third message indicating one or more second radio resources within at least one of the one or more bandwidth ranges

The computer program modules could essentially perform the actions of the flow illustrated in FIG. 2 through FIG. 5, to emulate the UEs or the network node. In other words, when the different computer program modules are executed in the processing unit 606, they may correspond to different modules in the UEs or the network node.

Although the code means in the embodiments disclosed above in conjunction with FIG. 6 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor.

The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the UEs and/or the network node.

Correspondingly to the method 200 as described above, an exemplary UE for LCP procedure selection is provided. FIG. 7 is a block diagram of a UE 700 according to an embodiment of the present disclosure. The UE 700 may be, e.g., the UE 100-1 or the UE 100-2 in some embodiments.

The UE 700 may be configured to perform the method 200 as described above in connection with FIG. 2. As shown in FIG. 7, the UE 700 may comprise: a receiving module 710 configured to receive, from a second UE, a first message indicating first COT information for sharing a first COT with the UE; and a selecting module 720 configured to select a first LCP procedure or a second LCP procedure based on one or more selection conditions in response to receiving the first message.

The above modules 710 and/or 720 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 2. Further, the UE 700 may comprise one or more further modules, each of which may perform any of the steps of the method 200 described with reference to FIG. 2.

Correspondingly to the method 300 as described above, an exemplary UE for LCP procedure reselection is provided. FIG. 8 is a block diagram of a UE 800 according to an embodiment of the present disclosure. The UE 800 may be, e.g., the UE 100-1 or the UE 100-2 in some embodiments.

The UE 800 may be configured to perform the method 300 as described above in connection with FIG. 3. As shown in FIG. 8, the UE 800 may comprise: a selecting module 810 configured to select one of a first LCP procedure and a second LCP procedure to build a first MAC PDU; a receiving module 820 configured to receive, from a second UE, a first message indicating first COT information for sharing a first COT with the UE; and a determining module 830 configured to determine whether the other of the first LCP procedure and the second LCP procedure is to be reselected in response to receiving the first message.

The above modules 810, 820, and/or 830 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 3. Further, the UE 800 may comprise one or more further modules, each of which may perform any of the steps of the method 300 described with reference to FIG. 3.

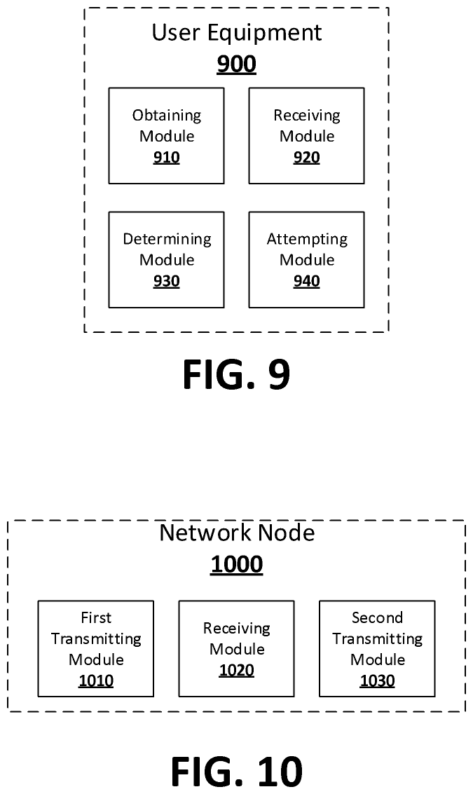

Correspondingly to the method 400 as described above, an exemplary UE for radio resource management is provided. FIG. 9 is a block diagram of a UE 900 according to an embodiment of the present disclosure. The UE 900 may be, e.g., the UE 100-1 or the UE 100-2 in some embodiments.

The UE 900 may be configured to perform the method 400 as described above in connection with FIG. 4. As shown in FIG. 9, the UE 900 may comprise: an obtaining module 910 configured to obtain one or more first radio resources; a receiving module 920 configured to receive, from a second UE, a first message indicating first COT information for sharing a first COT with the UE; a determining module 930 configured to determine whether the one or more first radio resources are within or overlapped with one or more bandwidth ranges where the first COT is shared; and an attempting module 940 configured to attempt to obtain one or more second radio resources within or overlapped with the one or more bandwidth ranges in response to determining that the one or more first radio resources are not within or overlapped with the one or more bandwidth ranges.

The above modules 910, 920, 930, and/or 940 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 4. Further, the UE 900 may comprise one or more further modules, each of which may perform any of the steps of the method 400 described with reference to FIG. 4.

Correspondingly to the method 500 as described above, a network node for facilitating a UE in radio resource management is provided. FIG. 10 is a block diagram of an exemplary network node 1000 according to an embodiment of the present disclosure. The network node 1000 may be, e.g., the gNB 105 in some embodiments.

The network node 1000 may be configured to perform the method 500 as described above in connection with FIG. 5. As shown in FIG. 10, the network node 1000 may comprise a first transmitting module 1010 configured to transmit, to the UE, a fourth message indicating one or more first radio resources for transmission associated with the UE; a receiving module 1020 configured to receive, from the UE, a second message for obtaining one or more radio resources within one or more bandwidth ranges; and a second transmitting module 1030 configured to transmit, to the UE, a third message indicating one or more second radio resources within at least one of the one or more bandwidth ranges.

The above modules 1010, 1020, and 1030 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 5. Further, the network node 1000 may comprise one or more further modules, each of which may perform any of the steps of the method 500 described with reference to FIG. 5.

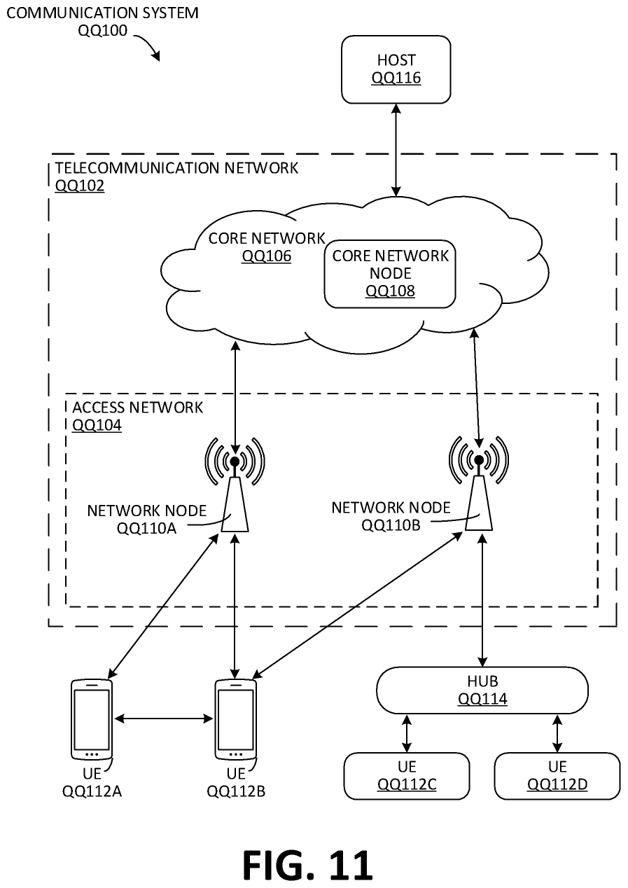

FIG. 11 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3^{rd} Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 11 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub-that is, a hub whose primary function is to route communications to/from the UEs from/to the network node QQ110b. In other embodiments, the hub QQ114 may be a non-dedicated hub-that is, a device which is capable of operating to route communications between the UEs and network node QQ110b, but which is additionally capable of operating as a communication start and/or end point for certain data channels.

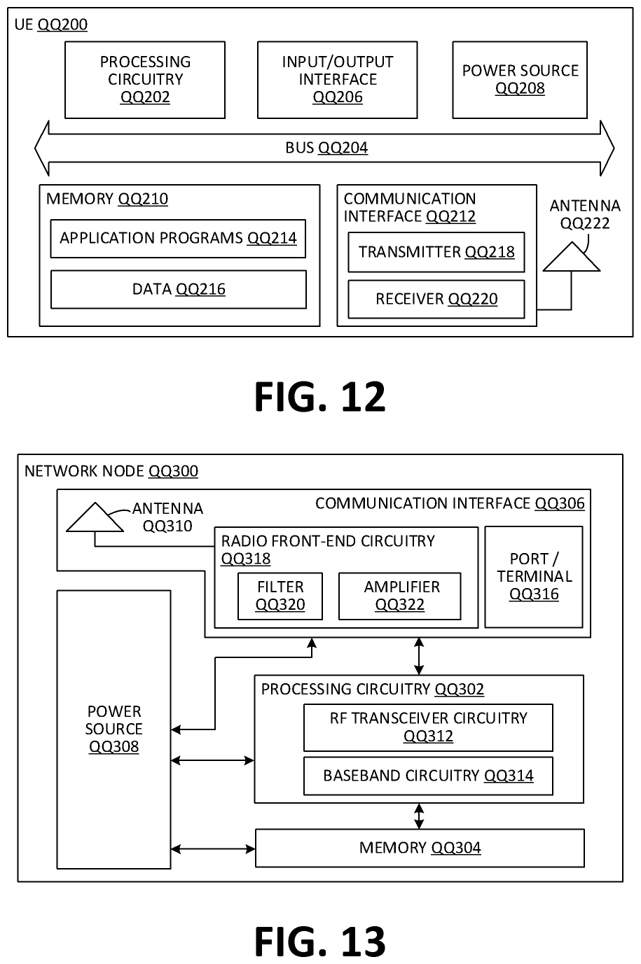

FIG. 12 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 12. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 12.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 13 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 13 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

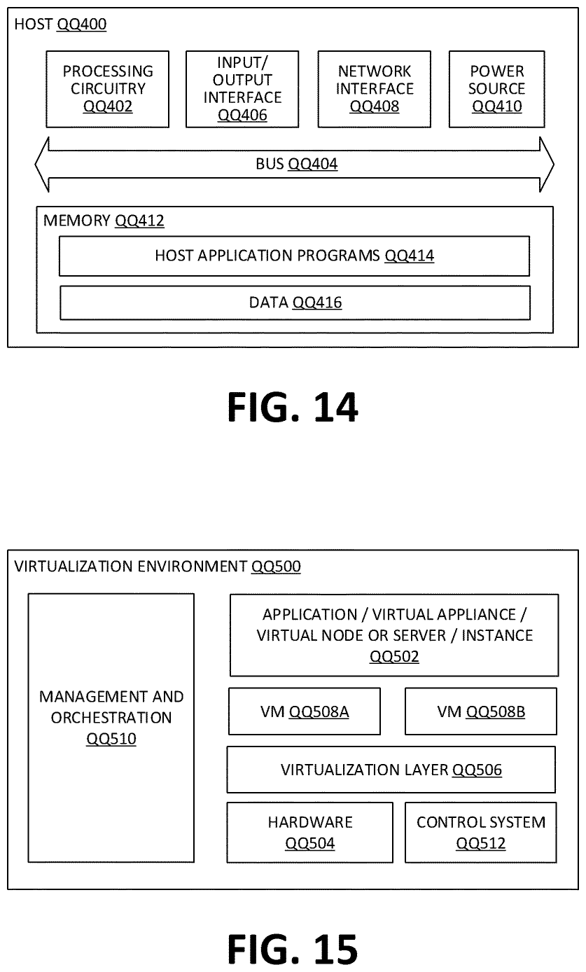

FIG. 14 is a block diagram of a host QQ400, which may be an embodiment of the host QQ116 of FIG. 11, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as FIG. 12 and FIG. 13, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 15 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment QQ500 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

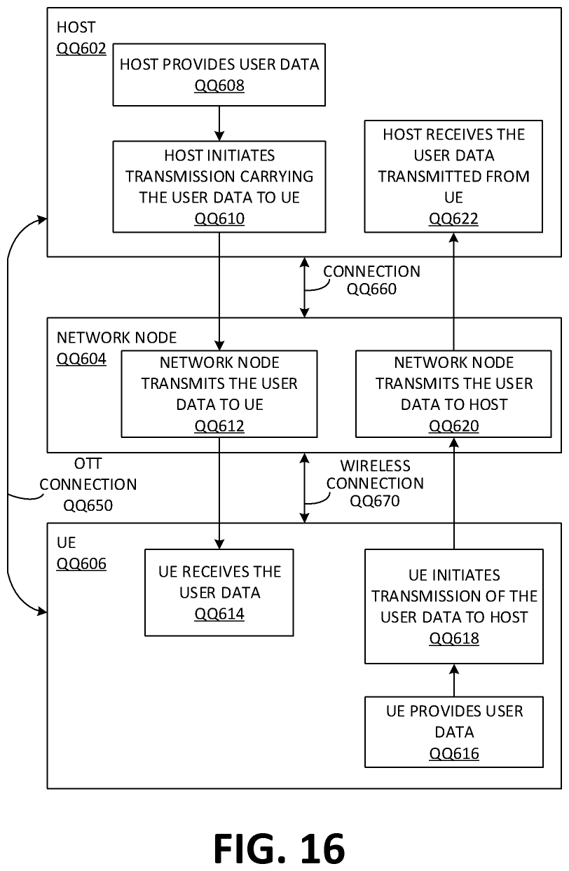

FIG. 16 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 11 and/or UE QQ200 of FIG. 12), network node (such as network node QQ110a of FIG. 11 and/or network node QQ300 of FIG. 13), and host (such as host QQ116 of FIG. 11 and/or host QQ400 of FIG. 14) discussed in the preceding paragraphs will now be described with reference to FIG. 16.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 11) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may improve the data rate, latency, power consumption and thereby provide benefits such as reduced user waiting time, relaxed restriction on file size, improved content resolution, better responsiveness, extended battery lifetime.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc. ; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

1. A method at a User Equipment (UE) for Logical Channel Prioritization (LCP) procedure selection, the method comprising:
receiving from a second UE, a first message indicating first Channel Occupancy Time (COT) information for sharing a first COT with the UE; and
selecting a first LCP procedure or a second LCP procedure based on one or more selection conditions in response to receiving the first message.

2. The method of claim 1, wherein a Logical Channel (LCH) is considered in the first LCP procedure only when it has a destination associated with the second UE.

3. The method of claim 1, wherein an LCH is considered in the second LCP procedure no matter whether it has a destination associated with the second UE or not.

4. The method of claim 1, wherein the UE has not started a LCP procedure to build a Medium Access Control (MAC) Protocol Data Unit (PDU) and/or a Transport Block (TB) for subsequent transmission.

5. The method of claim 4, wherein the one or more selection conditions comprise at least one of:
whether the UE has a second COT that is ongoing and has already gained access to its corresponding channel;
whether the UE has an ongoing Type-1 LBT procedure initiated by the UE itself;
whether one or more radio resources available to the UE and/or one or more radio resources obtained by the UE are within and/or overlapped with one or more bandwidth ranges where the first COT is shared;
whether a time gap between the time when the first COT information is received or the first COT is allowed to be shared and the time of the earliest radio resource that the UE has obtained or has potential to be obtained for subsequent transmission is less than, equal to, or greater than a threshold;
whether the UE's intended transmission towards the second UE has a Channel Access Priority Class (CAPC) value greater than a CAPC value associated with the first COT; and
whether the UE has pending traffic to be transmitted where the second UE is a target receiver of the pending traffic.

6. The method of claim 5, wherein the step of selecting first LCP procedure or a second LCP procedure comprises at least one of:
selecting the first LCP procedure in response to determining that the UE does not have a second COT that is ongoing and has already gained access to its corresponding channel; and
selecting the second LCP procedure in response to determining that the UE has a second COT that is ongoing and has already gained access to its corresponding channel.

7. The method of claim 5, wherein the second COT is triggered by the UE itself.

8. The method of claim 5, wherein the second COT is shared by a third UE.

9. The method of claim 8, wherein the second COT is able to be used for transmission to any Layer 2 (L2) destination identifier (ID).

10-13. (canceled)

14. The method of claim 5, wherein at least one of the one or more bandwidth ranges is indicated by at least one of:
one or more Physical Resource Block (PRB) ranges;
one or more sub-channel ranges;
a set of resource pools;
a part of one or more resource pools;
one or more LBT sub-bands; and
one or more LBT Bandwidth Parts (BWPs).

15. The method claim 5, wherein the one or more radio resources are obtained by the UE via at least one of:
Resource Allocation Mode 1; and
Resource Allocation Mode 2.

16-21. (canceled)

22. The method of claim 5, wherein the step of selecting a first LCP procedure or a second LCP procedure comprises at least one of:
selecting the first LCP procedure in response to determining that the UE has pending traffic to be transmitted where the second UE is a target receiver of the pending traffic; and
selecting the second LCP procedure in response to determining that the UE 2)-does not have pending traffic to be transmitted where the second UE is a target receiver of the pending traffic.

23. The method of claim 22, wherein before the step of selecting a first LCP procedure or a second LCP procedure, the method further comprises:
determining whether the pending traffic has a CAPC value, which is determined based on a PQI of the pending traffic, less than or equal to a CAPC value associated with the first COT;
wherein the step of selecting a first LCP procedure or a second LCP procedure comprises at least one of:
selecting the first LCP procedure in response to determining that the pending traffic has a CAPC value, which is determined based on the PQI of the pending traffic, less than or equal to the CAPC value associated with the first COT; and
selecting the second LCP procedure in response to determining that the pending traffic does not have a CAPC value, which is determined based on the PQI of the pending traffic, less than or equal to the CAPC value associated with the first COT.

24. The method of claim 1, wherein the selected LCP procedure is performed for sidelink (SL) communication.

25-67. (canceled)

68. A UE comprising:
a processor;
a memory storing instructions which, when executed by the processor, cause the processor to perform the method of:
receiving, from a second UE, a first message indicating first Channel Occupancy Time (COT) information for sharing a first COT with the UE; and
selecting a first LCP procedure or a second LCP procedure based on one or more selection conditions in response to receiving the first message.

69. A method at a network node for facilitating a UE in radio resource management, the method comprising:
transmitting, to the UE, a fourth message indicating one or more first radio resources for transmission associated with the UE;
receiving, from the UE, a second message for obtaining one or more radio resources within one or more bandwidth ranges; and
transmitting, to the UE, a third message indicating one or more second radio resources within at least one of the one or more bandwidth ranges.

70. The method of claim 69, wherein the second message indicates at least one of:
that the one or more first radio resources cannot be used;
a cause indicating that the one or more first radio resources are not within or overlapped with the one or more bandwidth ranges;
at least one of the one or more bandwidth ranges in which the UE expects to be granted with radio resources; and
a duration within which the UE expects to be granted with one or more radio resources in at least one of the one or more bandwidth ranges.

71. The method of claim 69, wherein the fourth message is a message used in Resource Allocation Mode 1 for allocating the one or more first radio resources to the UE.

72. The method of claim 69, wherein the one or more bandwidth ranges are one or more bandwidth ranges where a first COT is shared by a second UE with the UE.

73. The method of claim 69, wherein the one or more first radio resources and/or the one or more second radio resources are used for SL communication.

74-77. (canceled)
